(19) United States
(12) Patent Application Publication
(10) Pub. No.: US 2003/0048202 A1
(43) Pub. Date: Mar. 13, 2003

(54) Cockpit image recording system

(76) Inventor: Michael Francois, Wyoming, MI (US)

Correspondence Address: VARNUM, RIDDERING, SCHMIDT & HOWLETT LLP, P.O. BOX 352, GRAND RAPIDS, MI, 49501, US

(21) Appl. No.: 09/950,326

(22) Filed: Sep. 10, 2001

(51) Int. Cl. G08B 21/00

(52) U.S. Cl. 340/945; 340/425.5; 701/35; 348/143; 348/160

(57) ABSTRACT

A cockpit image recording system includes a dual resolution camera having a high resolution image capture mode and a low resolution image capture mode for alternately recording high resolution images representatives of the readings of instruments in the instrument panel and low resolution images representative of general cockpit activity.

### BACKGROUND OF THE INVENTION

It is generally acknowledged that data indicative of occurrences and conditions just prior to a crash of an aircraft, or other vehicle, are essential for proper after-crash analysis. For this reason, data recorders are commonly used in commercial aircraft for storing critical data representative of states and conditions of various elements, such as control levers and cockpit instruments, as well as data representative of aircrew microphone audio signals. Prior art flight data recording equipment typically includes a crash-protected recording device and electrical connections from each of a number of critical elements to the crash-protected recording device. Not all aircraft are equipped for recording critical data for after-crash analysis at time of manufacture, due to the expense of the required equipment. Furthermore, the addition of the necessary wiring and recording equipment is even more expensive when done on a retrofit basis. As a result, the desired crash-analyses equipment may not be installed in certain aircraft or other vehicles where recordation of critical data would be desirable.

To obtain further information of conditions prior to a crash, in particular, to determine whether smoke, fire or other emergency conditions have occurred, it has been proposed to mount a camera in the cockpit for recording cockpit conditions during flight. In order for such data to be useful for after-crash analysis, it must be recorded in a crash-protected memory. Furthermore, it is desirable to record both the specific setting of the flight control levers and readings of instruments in the cockpit instrument panel. For recording the settings of control levers, a standard, low-resolution camera can be used, but readings of instruments in the instrument panel are indistinguishable when recorded in a standard low resolution camera. However, the use of a high-resolution camera is impractical since for cockpit data recording since storage of high-resolution image data requires a great deal of storage space in the crash-protected memory and the crash protected memory is expensive and is difficult to expand.

### SUMMARY OF THE INVENTION

These and other problems of the prior art are solved in accordance with the present invention by a cockpit data recording system that includes a camera for recording readings of instruments in the instrument panel, as well as, recording movement and settings of control levers.

In accordance with one aspect of the invention, a dual resolution camera having a high-resolution image capture mode and a low-resolution image capture mode is mounted in the cockpit and is directed such that both the instrument panel and the control levers are in the field of view of the camera.

In accordance with a further aspect of the invention, the camera is controlled to periodically switch between the high-resolution capture mode and the low-resolution capture mode.

Advantageously, movement and settings of control levers recorded are adequately recorded in the low-resolution capture mode of the camera and readings of the instruments in the instrument panel are adequately recorded by periodically providing images in the high-resolution capture mode;

Advantageously, well-known, standard high-speed download and replay tools that run on standard personal computers allow for viewing, on a frame by frame basis, of the recorded high-resolution and low-resolution image data.

Furthermore, in accordance with this invention, both general cockpit activity and instrument readings are recorded under all normal cockpit lighting conditions.

In accordance with one aspect of the invention, image capture and compression circuitry within the camera are controlled in real time to alternately record low-resolution images and high resolution images;

In one embodiment of the invention, low resolution images are preferably recorded for a relatively long period of time and high-resolution images are recorded for a relatively shorter period of time.

In one embodiment of the invention, both high-resolution and low-resolution image data generated by the camera are transmitted to a crash-protected memory and stored for later recovery.

Advantageously, in accordance with this invention, the need for expensive wiring from each of variety of control levers and instruments to a data recorder is eliminated. Furthermore, a need for memory space in a costly crash-protected memory, such as would be required for continuous storing of high-resolution instrument panel data, is greatly reduced.

In one particular embodiment of the invention, the dual-resolution camera includes image capture circuitry and control circuitry for controlling the image capture circuitry to periodically capture high-resolution image data and a low-resolution data.

In accordance with one aspect of the invention, camera image data are periodically transferred from the camera to a crash-protected memory for after crash analysis.

In one particular embodiment of the invention, the recording system captures the last 30 minutes, or more, of crew audio, cockpit instrument and cockpit condition data.

### BRIEF DESCRIPTION OF THE DRAWINGS

FIG. 1 is a diagrammatic representation of a cockpit image recording system, incorporating principles of the invention;

FIG. 2 is partial perspective view of a camera mounted in a cockpit in accordance with one embodiment of the invention.

### DETAILED DESCRIPTION

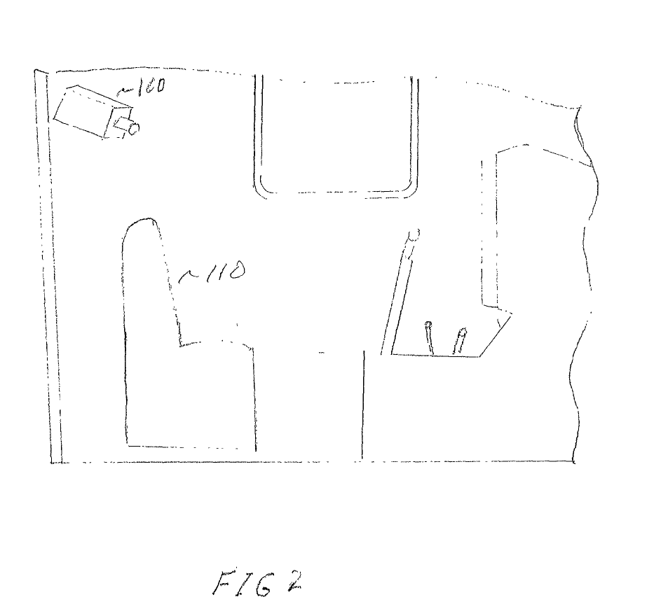

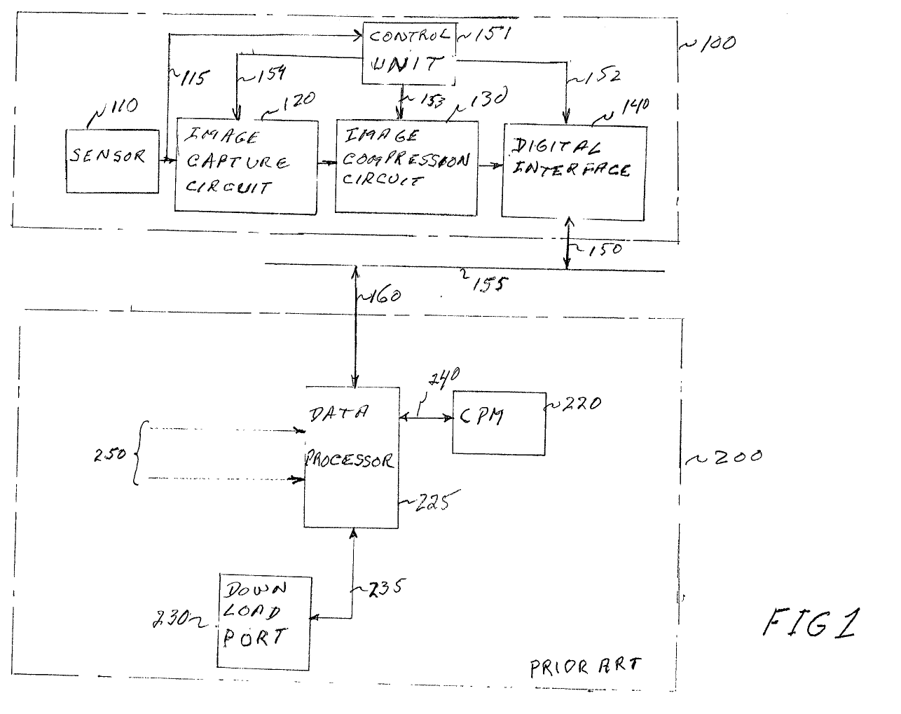

Referring to FIGS. 1 and 2, there is shown in FIG. 1 a cockpit-image recording system including a digital camera 100 connected to a flight data recorder unit 200. The recorder unit 200 is a commercially available, crash-protected memory system such as is commonly used in commercial aircraft. The camera 100 is preferably mounted in the cockpit in a manner generally depicted in FIG. 2 and data signals provided by the camera are stored in the recorder unit 200. In the illustrative embodiment depicted in FIG. 2, the camera 100 is positioned adjacent the co-pilot position 110 is directed to the pilot position (not shown in the drawing). The camera is preferably positioned to record images of instruments in the pilot instrument panel, images of the settings of control levers adjacent the pilot position and images reflecting general cockpit conditions. In the present embodiment, a single cockpit camera is used in a fixed position. It will be understood that more than one camera can be used, directed to different areas of the cockpit for more complete image recording coverage. The exact position of the camera or cameras is not critical to the invention and the camera may be located in different positions, as desired, and in different areas of the cockpit to record cockpit conditions and instrument panel readings, as desired.

Referring again to FIG. 1, there is shown the camera 100, in block diagram form, connected to a prior art and commercially available recording system 200, such as is commonly used in commercial aircraft. The camera 100 and the recording system 200 are interconnected via a standard data bus 155. Data representative of cockpit recordings are transmitted from the camera 100 to the bus 155 via bus interface 150 and from bus 155 to the recording system 200 via bus interface 160.

The recording system 200 may be a standard prior art data recording system including a prior art data processor 225 and a prior art crash-protected memory 220. The processor 225 receives data from the camera 100 via data bus 155, and from a plurality of inputs 250. The inputs 250 are preferably connected to various prior art input devices providing input data representative, for example, of aircrew audio signals, positions of various control levers, and the like. Processor 225 stores the received data in the crash-memory 220. The processor 225 is preferably accessed via a well-known, high-speed download data port 230. The download data may be displayed using well-known replay tools that run on a standard computer, to allow for continuous motion or frame-by-frame replay and analysis of the various recorded data.

Referring again to FIG. 1, the camera 100 includes a sensor 110, image capture circuitry 120, image compression circuitry 130 and a digital interface 140. All of which are well known elements and commonly found in digital cameras. The camera 100 further includes a control unit 151 comprising logic and timing circuitry and may be a standard, commercially available microprocessor. The control unit 151 monitors output signals of sensor 110 and controls the image capture circuitry 120 and the image compression circuitry 130 to capture and compress incoming signals, alternately, in the high-resolution mode and in the low resolution mode. The control unit 151 further controls the digital interface 140 to periodically transfer the compressed high-resolution and the low resolution image data from the compression circuit 130 to bus 155, for storage in the crash-protected memory 220.

In one particular embodiment of the invention, a high-resolution image comprises on the order of 1600×1200 viewable pixels and a low-resolution image comprises on the order of 320×240 viewable pixels. Frame rates of greater than 10 frames per second are preferred.

The control unit 151 further controls the digital interface 140 to periodically transmit recorded image data to the recording system 200. For one particular application, the camera 100 is programmed to record high-resolution image frames to capture detailed readings of instruments in the instrument panel to which the camera is directed, at the rate of ten frames per minute. Low-resolution frames capturing settings or movements of control levers and the like in the cockpit, but not in sufficient detail to distinguish instrument readings, are recorded at the rate of six frames per second. In one particular application, both the high-resolution frame data and the low-resolution frames are compressed in the image compression circuit 130, with the high-resolution frame data being compressed at a higher compression ratio than the low-resolution frame data.

As mentioned earlier, the camera 100 is a dual resolution camera and is operated, alternately, in a high-resolution mode providing sufficient detail for reading of instruments in the instrument panel and in a low-resolution mode providing image data of control lever settings and movements. For one particular embodiment application, the control circuitry controls the camera to records high-resolution images at the rate of ten frames per minute and low resolution images at a rate of six frames per second. The camera may be readily adjusted to switch between recording of high-resolution. For example, the camera may be programmed to record high-resolution image frames, showing small image detail such as instrumentation, several times a minute and to record a low resolution frames, i.e., showing general cockpit activity, but not in sufficient detail to distinguish instrument readings, several times a second. Since the low resolution frames allow a greater rate of compression than high resolution frames, a substantial amount of low resolution data may be stored in a standard sized crash protected memory. In one particular embodiment of the invention, 30 minutes of high-resolution instrumentation image data and 30 minutes of low-resolution cockpit activity data are recorded in the crash-protected memory, in a standard digital format, together with data recording 30 minutes of aircrew audio.

The dual resolution camera 100 may receive its required electrical power from the standard 28 volt DC aircraft power system. In addition, an emergency 28 volt system may be provided, independent from the standard aircraft power, to supply both the dual resolution camera and the combination recorder unit.

While repeated reference has been made in the description to the use of data recorders in aircraft, it will be understood that data recorders in accordance with the present invention are equally useful in trains and other vehicles for the recordation of critical data.

1. Apparatus for recording image data representative control lever settings and instrument readings, said apparatus comprising:
a dual-resolution camera controllable to alternately record images of a first, high resolution representative of instrument readings and images of second resolution, lower than said first, high resolution.

2. The apparatus in accordance with claim 1 and further comprising control circuitry for selectively controlling said camera to record said images of said first high resolution for a first period of time and to record said images of said second resolution for a second period of time differing from said first period of time.

3. The apparatus in accordance with claim 2 and further comprising a data storage memory and wherein said control circuitry is operative to periodically transfer date representing said images of said first resolution and images of said second resolution to said data storage memory.

4. The apparatus in accordance with claim 3 wherein said data storage memory is a crash-protected memory.

5 A cockpit status recording system comprising:
a high-resolution camera responsive to control signals to selectively record images of a first predefined resolution and images of a second predefined resolution, lower than said first predefined resolution;
a memory; and
a controller operative to periodically transfer data representative of said images of said first predetermined resolution and data representative of said images of said second predetermined resolution from said camera to said memory.

6. The recording system in accordance with claim 5 wherein said camera comprises a camera lens and said camera is mounted in a cockpit of having a predefined general cockpit area and an instrument panel and wherein said camera is positioned in said cockpit such that said lens is directed toward said predefined general area and said instrument panel.

7. In combination, a dual resolution camera and an operator position having control levers and instruments for recording status of selected operating units;
said camera operative to alternately record images at a first high resolution and images at a second resolution lower than said first resolution;
said camera directed towards said operator position for recording images of said operator position and said levers at said first low resolution for a first predetermined period of time and for recording images of said instruments at said second low resolution for a second predetermined period of time.

8. The combination in accordance with claim 7 and further comprising a crash-protected memory and wherein said camera is operative to periodically transmit said images to said crash-protected memory.

9. A photographic image recording system for recording high resolution images and low resolution images, said system comprising;
image capture circuitry for receiving and capturing signals representative of a received image;
image compression circuitry connected to the image capture circuitry for receiving and compressing said signals representative of a captured image; and
control circuitry for controlling the image capture circuitry and the image compression circuitry to selectively capture and compress received images to alternately provide output signals defining high resolution images and low resolution images.

10. The system in accordance with claim 9 and further comprising interface circuitry and a memory, said interface circuitry responsive to signals generated by said control circuitry to selectively transfer said output signals to said memory.
